(19) United States
(12) Patent Application Publication
(10) Pub. No.: US 2013/0058274 A1
(43) Pub. Date: Mar. 7, 2013

(54) METHOD AND SYSTEM FOR ACCESSING WIRELESS NETWORKS

(71) Applicants: Shimon Scherzer, Ramot HaShavim (IL); Tamir Scherzer, IL (IL)

(72) Inventors: Shimon Scherzer, Ramot HaShavim (IL); Tamir Scherzer, IL (IL)

(73) Assignee: WEFI INC., Tel Aviv (IL)

(21) Appl. No.: 13/486,640

(22) Filed: Jun. 1, 2012

Related U.S. Application Data
(63) Continuation-in-part of application No. 11/441,827, filed on May 25, 2006.
(60) Provisional application No. 61/492,122, filed on Jun. 1, 2011.
(60) Provisional application No. 61/587,228, filed on Jan. 17, 2012.
(60) Provisional application No. 61/492,122, filed on Jun. 1, 2011.
(60) Provisional application No. 61/587,228, filed on Jan. 17, 2012.
(60) Provisional application No. 60/776,444, filed on Feb. 23, 2006.
(60) Provisional application No. 60/772,084, filed on Feb. 9, 2006.
(60) Provisional application No. 60/728,918, filed on Oct. 21, 2005.
(60) Provisional application No. 60/687,463, filed on Jun. 3, 2005.

(51) Int. Cl. H04W 48/08

(52) U.S. Cl. 370/328

(57) ABSTRACT

A method and system for distributing network access information by wireless network owner includes using information associated with the user of a mobile terminal to identify potential friends and colleagues that may need access to wireless networks owned or managed by friends and colleagues. The distribution process can be initiated by the candidate user or by the network operator. The information associated with the user can include the user's contacts list or information available from other sources, such as a social networking website. When a candidate is identified, the user's terminal or a server, on behalf the user, can send a communication to network operator requesting access to their wireless network access point. The friend or colleague can verify the pre-existing relationship by searching for the operator in a private database, such the friend or colleague's contacts list or by searching another database, such as a social networking website.

### CROSS-REFERENCE TO RELATED APPLICATIONS

This application claims benefit under 35 U.S.C. §119(e) of U.S. Provisional Patent Application Ser. Nos. 61/492,122 filed Jun. 1, 2011 and 61/587,228 filed Jan. 17, 2012, and is a Continuation-in-Part of U.S. patent application Ser. No. 11/441,827 filed May 25, 2006, which claims benefit as applicable under 35 U.S.C. Sections 120, 121 or 365(c), and which claims benefit under 35 U.S.C. §119(e) of U.S. Provisional Patent Application Ser. Nos. 60/776,444 filed Feb. 23, 2006, 60/772,084 filed Feb. 9, 2006, 60/728,918 filed Oct. 21, 2005 and 60/687,463 filed Jun. 3, 2005, the contents of each of which are hereby incorporated by reference in their entirety.

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

The present invention is directed to methods and systems for connecting terminals to wireless networks and for distributing wireless network access profiles to enable wireless terminals to connect to wireless networks. Specifically, the invention relates to enabling wireless terminals to select between using wireless LAN connections and mobile/telephony connection for both data and voice services by providing wireless network access profile information to enable wireless terminals to use wireless LAN facilities when they are available.

2. Description of the Prior Art

Most households and small businesses employ WiFi routers to support Internet access. Internet access through each router can be legitimately used by a set of users including the router owner, his family, close friends, etc or the business owner and permitted employees. When the router is used by a small business (SMB), the list of permitted users can be large and may substantially grow to include guests, such as customers and service providers. Effectively, each router becomes associated with a set of users and each user has a set of routers that are candidates for providing Internet access.

### SUMMARY

Many locations provide Internet access using wireless networks and associated wireless routers or access points, for example, using WiFi (e.g., IEEE 802.11 based wireless networking). Many of these wireless networks are secured so that the network owner can control access to their wireless networks. Access to these secured networks can be provided with wireless access profile information, including for example, credentials and by other means (e.g., passwords or keys) to enable a user to access a secured network. Regardless of the method, the wireless user terminal is allowed to connect to the wireless network because the operator (or owner) of the wireless network has granted access, for example, the operator provided the wireless user with information that enables the user's wireless terminal to access the secured network. Each network and more specifically, each router, can be associated with a set of permitted users or wireless user terminals and each user or user terminal includes a set routers or wireless networks that are candidates for providing Internet access. The process of determining the above sets (associating users or wireless terminals and wireless access points) is herein referred to as “pairing”. In other words, pairing is herein defined as identifying a set of access networks that potentially can be used by a specific user and a set of users that can potentially be given access by a specific access networks, and the process that enable this access. The present invention includes a method and system for integrated discovery and passwords sharing to facilitate legitimate Internet access through these candidate access points.

The WiFi Alliance has established several methods for simplifying secure network connection setup at home/office known as WiFi Protected Setup (WPS). Implementing WPS in wireless routers and wireless terminals requires substantial modification to the current WiFi standard implemented in these devices including changes in router's firmware and user terminal's behavior via software. The present invention includes a method and system that provides a simpler way to achieve network connection setup by leveraging the fact that mobile terminals usually include at least two network connections, for example, cellular data (3G or 4G) and WiFi.

Furthermore, out of band communication (such as via, cellular data 3G, and 4G networks) can eliminate the need for most of current enterprise WPA-PSK methodology since these connections can be used to securely distribute the access profile information to the user terminal to enable wireless access.

Embodiments of the present invention are directed to facilitating and encouraging the sharing of internet access in a convenient way. In accordance with some embodiments of the invention, network operators (or owners) can grant Internet access to users that are identified to them as sufficiently closely related through an easy and seamless procedure. In addition, the procedures for obtaining Internet access avoid the need for requesting user to formally request Internet access and therefore eliminate “fear of rejection” that can sometimes prevent users from seeking access.

In accordance with some embodiments of the invention, an automated system uses available information to identify and detect potential users who have an apparent relationship with the network operator (or owner) and who can safely be granted network access by the network operator (or owner) with low probability of error, and propose to the owner to share network access with these users. In addition, as the relationship between the network operator (or owner) and the potential user evolves over time, the system can determine a preselected point when the user is eligible to seek or receive network access.

### BRIEF DESCRIPTION OF THE FIGURES

FIG. 1 is a block diagram of a system according to an embodiment of the invention.

FIG. 2 is a block diagram of a system according to an embodiment of the invention.

FIG. 3 is a block diagram of a system according to an embodiment of the invention.

FIG. 4 is a block diagram of a system according to an embodiment of the invention.

FIG. 5 is a flow chart of a method for detecting and verifying candidate users that are likely to share wireless network access with a visitor according to an embodiment of the invention.

FIG. 6 is a flow chart of a method for configuring a network operator's mobile terminal according to an embodiment of the invention.

FIG. 7 is a flow chart of a method for updating a mobile terminal with a network access profile according to an embodiment of the invention.

FIG. 8 is a flow chart of a method for updating a personal computer with a network access profile according to an embodiment of the invention.

FIG. 9A is a flow chart of a method for registering a mobile user with a system and installing a related application program on their mobile device according to an embodiment of the invention.

FIG. 9B is a flow chart of a method for identifying candidate users to share network access profiles with according to an embodiment of the invention.

FIG. 10 is a flow chart of a method for determining frequent or favorite places to access wireless networks according to an embodiment of the invention.

FIG. 11 is a flow chart of a method for updating or synchronizing network access profile information according to an embodiment of the invention.

### DETAILED DESCRIPTION OF PREFERRED EMBODIMENTS

The present invention is directed to a method and system for distributing wireless network access profiles to enable wireless network devices to access secured wireless networks. These wireless network devices can, for example, use these secured wireless networks to off-load both data and voice services from congested or lower performing carrier networks. As more devices include the capability to transmit over more than one wireless network, for example, using wireless telephone networks (e.g., cellular, 3G, 4G) and using wireless data network (e.g., WiFi and WiMAX), the ability offload voice or data traffic or both onto the higher availability network provides benefits to both users and carriers. Users benefit because they have the opportunity to utilize one or both networks for improved user experience without increased cost. The carriers benefit by being able to offload bandwidth to another network without increased expense. However, many wireless data networks are secured by passwords or other means that prevent uninvited or authorized users from accessing this wireless network. Thus, only invited or authorized users, who have been provided the wireless network access profile information, are able to access the Internet through these secured wireless networks.

The present invention provides a highly scalable method and system for distributing wireless network access profiles that can accommodate a large number of potential users and routers. The present invention can further provide a method and system that preserves a users' privacy and avoids the unauthorized transfer of sensitive user information. Further, the present invention can provide for a seamless transaction where the users involvement can be minimized and the possibility of distributing passwords to unwanted users is minimized.

These secured wireless networks are usually managed by one or more network operators, which can include the network owner or one or more persons or entities, authorized by the owner to manage the wireless network. The network operators have access to the network access profile information that can include, for example, the password or other credentials needed to access the wireless network. In general, a network access profile can include an access point identifier, such as an SSID and/or MAC address, providing a wireless terminal or device with a way to identify the access point and credentials (e.g., password and/or access keys, codes. biometric data) and, possibly other information (e.g., configuration settings and data) needed by a wireless network user to establish a wireless connection with the access point and connect to the Internet. These operators can have the ability to distribute the network access profile, either manually or via an automated system. Thus, a user requesting access to a secured wireless network can contact the operator to obtain the necessary network access profile information to connect to the wireless network. In some configurations, the network access profile can be stored on the operator's computer or other wired or wireless device for use in connecting to the wireless network. In other configurations, the network access profile can be stored in a central storage location (e.g., a central database server) that is accessible by the operator's computer or other wired or wireless device. The operator is referred to as the network profile supplier and this includes any user authorized by a network operator to distribute network access profile information or to authorize others to distribute network access profile information. In general, the user of a mobile wireless terminal that desires access to a wireless network access point will be referred to as a candidate user and their mobile wireless terminal will be referred to as a candidate terminal. In accordance with various embodiments of the invention, a supplier can send or cause a third party to send network access profile information to a candidate terminal, thus authorizing that candidate terminal and the candidate user to access a wireless network access point.

In accordance with some embodiments of the invention, the candidate users and applications executed on the candidate terminals can identify wireless network access points that the candidate user or candidate terminal desires to gain access to. In order to gain access to a given wireless access point, the candidate user or candidate terminal can utilize embodiments of the invention to identify the operator the wireless network access point and either directly or indirectly request access. Access can be granted by the delivery of network access profile information to the candidate terminal.

In accordance with some embodiments of the invention, the operators, for example, using their wireless terminals or their desktop terminals (e.g., PCs) can identify candidate users or candidate terminals to grant access to without receiving a request for access. In accordance with these embodiments, the operator terminals can identify users having a sufficiently close relation (e.g., a family member, close friend, an employee or a customer) to be able to infer the desirability to grant access before it is requested.

In accordance with one embodiment of the invention, a candidate wireless terminal identifies a wireless access point that it desires to connect to. Where the wireless access point is unsecured, the candidate wireless terminal can connect, as needed, to the open wireless access point. However, where the wireless access point is secured, such as by a WEP/WPA or other password or access key, or includes a captive portal requiring credentials for access, the candidate user of the candidate terminal must obtain this access profile information from (or with the permission of) the network access point operator, in order to establish a wireless network connection with the wireless network access point. The candidate user or candidate terminal will need to identify the network access point operator (or an entity authorized by the network operator) in order to contact them with a request for the access profile information. The network operator can be identified manually (input by the user of requestor terminal) or automatically based on contextual information (e.g., location information, SSID name) or automatically by searching for an access point identifier in a list or database. After the network operator is identified, the system can determine whether there is a relationship between the network operator and the candidate user of the candidate terminal and a measure of closeness of the relationship. In accordance with some embodiments, a relationship coefficient can be determined as described in commonly owned U.S. patent application Ser. No. 13/458,420, entitled Dynamic Network Connection System and Method, the entire contents of which are hereby incorporated by reference.

After identifying the wireless network access point operator (e.g., the supplier), the candidate terminal can send a network access profile request to a supplier terminal. The supplier terminal can be a terminal operated by the network operator or a terminal authorized to distribute network access profile information in behalf of the operator. The supplier terminal can be a mobile terminal of the network operator, a network server or cloud based service operated by or on behalf of the network operator. In accordance with some embodiments, the supplier terminal can store and distribute access profile information for one or more wireless network access points. The supplier terminal can also store operator identifier information for one or more wireless network access points and provide (or provide access to) an operator identifier lookup service to enable candidate users and candidate terminals to identify network operators. And in accordance with other embodiments, the supplier terminal can authorize another terminal, such as a central database server, that stores access profile information for one or more wireless network access points to distribute that information to the candidate terminal. Upon receipt of a network access profile request, the supplier terminal can evaluate the request, optionally seeking user (e.g., owner or operator) approval to transfer the network access profile to the candidate user or candidate terminal. If the request is approved, the network access profile can be transferred to the candidate terminal, for example, in an email or text message. In accordance with some embodiments of the invention, the network access profile can be transmitted directly to the candidate terminal. In accordance with some embodiments of the invention, an intermediary server or service that interacts with candidate terminals can be authorized and can send the network access profile to one or more of the candidate terminals. The candidate terminal can store the network access profile information in local memory and use it to connect to a secured WiFi networks in order to offload voice and/or data onto the WiFi network.

In accordance with other embodiments of the invention, the network operator terminal can determine that a candidate user has a sufficient level of relatedness to the network operator (e.g., based on communication frequency and/or other available information) that the operator terminal can offer to send or send the network access profile to that candidate user's terminal without receiving a profile request.

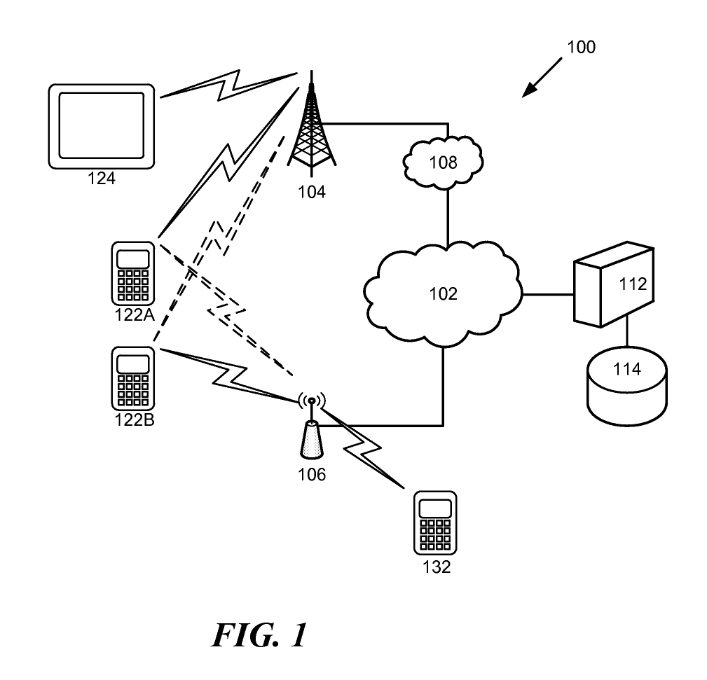

FIG. 1 shows a system 100 for distributing network access profile information according to some embodiments of the invention. System 100 can include a first wireless network 108, such as a cellular phone network 108, connected to a first wireless access point 104 (e.g., a cell tower) and a data network 102 (e.g., the internet). System 100 can also include one or more second wireless access points 106 connected through one or more network service provider (e.g., ISP) networks (not shown) to network 102. The system 100 can also include one or more wireless terminals 122A, 122B, 124, 132, including, for example, cellular telephones, smart phones, tablet computers, laptop computers and other portable wireless devices. Many of these wireless terminals, for example, smart phones 122A and 122B and tablet computer 124 can include one radio for connecting cellular access point 104 for communicating over the cellular phone network 108 (e.g., voice and data) and a second radio for connecting to local wireless access points 106 to connect to network 102. In this illustrative example, tablet computer 124, smart phone 122A and smart phone 122B are candidate terminals shown in various states. Tablet computer 124 can connect to network 102 through the cellular network 108 by connecting to cell tower 104, but its WiFi radio is off, so it is not able to detect and connect to wireless access point 106. Smart phone 122A can be connected to network 102 through the cellular network 108 and at the same time list for and detect other wireless access points, such as WiFi access point 106. Smart phone 122B can be connected to network 102 through the WiFi access point 108 and at the same time connect to the cellular network 108 through first wireless network access point, cell tower 104. Assuming that wireless access point 106 is either unsecured or that smart phone 122A and smart phone 122B have obtained the network access profile for wireless access point 106, the smart phones 122A and 122B can connect to network 102 through first network access point 104 or second network access point 106 as desired. The system 100 can also include server terminal 112 connected to network 102 and operator terminal 132. While the operator terminal 132 can be considered a candidate terminal (e.g., for access points not managed by the operator), the operator terminal 132 can also be a supplier terminal that delivers or authorizes the delivery of network access profile information to candidate terminals. The server terminal 112 can include storage 114 for storing data, such as a database. In some embodiments of the invention, the server terminal 112 can be a network cloud based service that appears to user terminals as server terminal. The database can store information about network access points, such as second network access point 106, including, one or more access point identifiers, network access profile information and network operator information. Operator terminal 132 can be provided to enable the network operator to interact with and manage the system 100.

Each of the terminals 122A, 122B, 124, 132 and 112 can include one or more processors and associated volatile and non-volatile memory for storing programs and data and executing programs and software modules to manipulate and process data. The various functions and features of the invention can be implemented in one or more programs or software modules or components. In some embodiments, the functions and features of the invention can be implemented in a distributed fashion where a portion of a feature or function is executed at one terminal and another portion of the function or feature is executed at another terminal. For example, smart phone 122A, using one or more software modules, can detect wireless network access point 106 and identify its SSID and MAC address; smart phone 122, using the same or different software modules can submit a database query with SSID and/or MAC address to database server 112 to request the identity of the owner of wireless network access point 106. Database server 112 can include one or more software modules that receive the database query, execute the database search according to the query, retrieve the results from the database and send the results of the query back to the smart phone 122A. The results of the query can include, for example, the phone number or email address of the operator of the second wireless network access point 106. At the smart phone 122A, the same or different software modules can receive the results of the query and formulate a communication, such as telephone call, a text message or an email to send to the operator terminal 132 to request access to second network access point 106. Operator terminal 132 can include one or more software modules that receive the communication requesting access and process the information contained in the request to determine whether to grant access to the second wireless access point 106.

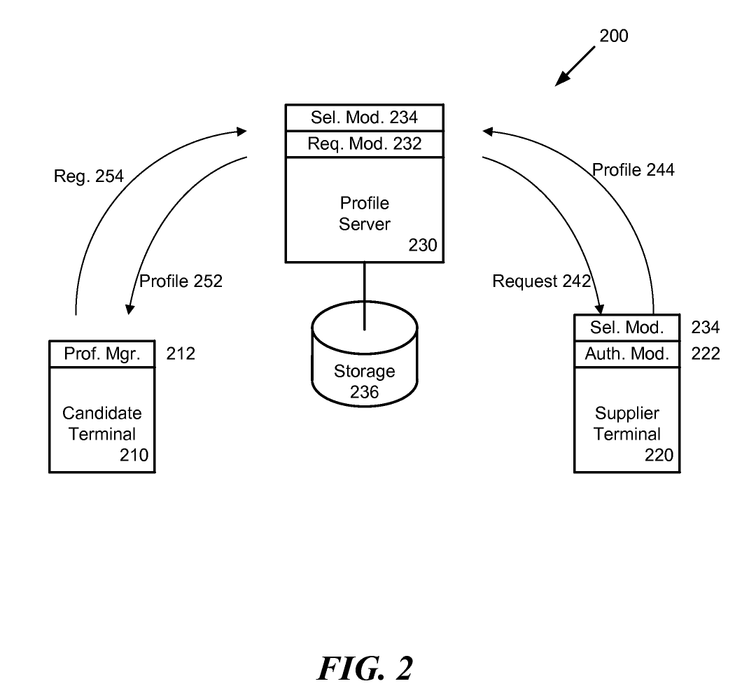

FIG. 2 shows a system 200 for distributing network access profile information according to an embodiment of the invention. The network access profile information allows a candidate terminal 210 to connect to a wireless network (e.g., WiFi network) through a wireless network access point operated by the user of a supplier terminal 220. In this embodiment, a profile server 230 can also be provided to facilitate the communication between the candidate terminal 210 and the supplier terminal 220. The profile server 230 can include a computer processor and associated memory and execute one or more computer programs or software modules that provide, in cooperation with the hardware components (e.g., radios and network interfaces), the functionality described herein. In this embodiment, the profile server 230 and the supplier terminal 220 are in communication via a communication network (e.g., cellular, Ethernet, WiFi) 102 and the profile server 230 sends a request 242 to the supplier terminal 220 requesting network access profile information for a particular network access point which the user of the supplier terminal 220 owns or operates. The request 242 can be any form of communication, including an email, a text message, or proprietary message sent using a proprietary message protocol. Some or all of the message can be encrypted and/or protected using, for example, a digital signature or similar device.

The supplier terminal 220 can include a computer processor and associated memory and execute one or more computer programs or software modules that provide, in cooperation with the hardware components (e.g., radios and network interfaces), the functionality described herein. The supplier terminal 220 can further include an authorization module 222 which receives the request 242 and processes the information in the request 242 to determine whether to authorize the transfer of the network access profile to the candidate terminal 210. There are many methods and algorithms for determining whether to authorize the candidate terminal 210. For example, in accordance with some embodiments of the invention, the candidate terminal 210 can include a profile manager module 212 that communicates with the profile server 230 by sending a registration request 254 to the profile server 230 and receiving network access profile information 252 from the profile server. The registration request 254 can include information identifying a wireless access point that the candidate terminal 210 desires network access profile 252 for. In accordance with some embodiments of the invention, the request 242 can include user information and some or all of the user information can be found (such as, by searching) in a database, such as, a contacts list or an authorized user list stored on the supplier terminal 220 or a database stored on the profile server 230. The authorization module 222 can also present a message or dialog box to the user of the supplier terminal 220 requesting the operator to authorize the candidate user of candidate terminal 210 to receive the network access profile. Upon confirmation, the network access profile message 244 can be sent to the profile server 230. The profile server 230 can send the network access profile message 252 to the requestor terminal 210. The candidate terminal 210 can include a computer processor and associated memory and execute one or more computer programs or software modules that provide, in cooperation with the hardware components (e.g., radios and network interfaces), the functionality described herein. The candidate terminal 210 can use the network access profile information to access the wireless network (e.g., WiFi) owned or operated by the user of the supplier terminal 220. The candidate terminal 210 can use the wireless network for voice and/or data communications at that location. The candidate terminal 210 can also measure and store information about the performance of the wireless network each time it is accessed.

In accordance with some embodiments of the invention, the profile server 230 can also store the network access profile information in a database or other data store in storage component 236 to enable the profile server to act as a profile server or proxy for the supplier terminal 220. In this embodiment, once a supplier terminal 220 is registered with the profile server 230, the supplier terminal 230 can authorize the distribution of one or more network access profiles by sending a profile message 244 identifying each candidate user and the one or more network access profiles authorized for that candidate user, to the profile server 230. The profile server 230 can process these profile messages 244 and distribute the network access profiles 252 accordingly. The profile server 230 can also keep track of the network access profiles authorized for each candidate user and/or candidate terminal in a database or other data store in storage component 236. Should a candidate user obtain a new wireless terminal or need wireless network access from a different candidate terminal, the candidate user can request the network access profiles from the profile server 230.

According to some embodiments of the invention, the network operator or the network operator terminal can store identifier information that a given candidate user or candidate terminal is approved for access to a given wireless access point in a database on the profile server 230 (or the network operator terminal) along with the network access profile information and the candidate terminal can access the profile server 230 (or the network operator terminal) using the identifier information to retrieve the network access profile information. In accordance with some embodiments of the invention, a program such as a network connection manager can be used to access the profile server 230 to retrieve and store the network access profile information.

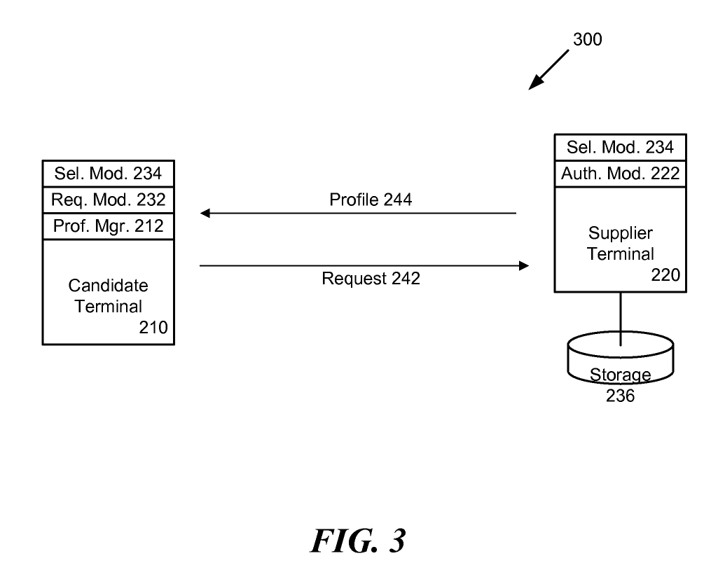

FIG. 3 shows a system 300 for distributing network access profile information according to an alternate embodiment of the invention. The network access profile information allows a candidate terminal 210 to connect to a wireless network access point (e.g., WiFi network) owned or managed by a network operator. The supplier terminal 220 can be a wireless user terminal of the network operator (e.g., a smart phone or portable computer) or wired terminal operated or authorized by the network operator. This embodiment differs from the embodiment of FIG. 2 in that no a profile server 230 is available to facilitate the communication between the requestor and the supplier. In this embodiment, the candidate terminal 210 and the supplier terminal 220 can be in direct communication via a communication network (e.g., cellular, Ethernet, WiFi) 102 and the candidate terminal 210 can send a request 242 to the supplier terminal 220 requesting network access profile information for a particular network access point which the network operator. The request 242 can be any form of communication, including an email, a text message, or proprietary message sent using a proprietary message protocol. Some or all of the message can be encrypted and/or protected using a digital signature or similar device.

The supplier terminal 220 can include a computer processor and associated memory and execute one or more computer programs or software modules that provide, in cooperation with the hardware components (e.g., radios and network interfaces), the functionality described herein. The supplier terminal 220 can further include an authorization module 222 which receives the request 242 and processes the information in the request 242 to determine whether to authorize the transfer of the network access profile to the candidate terminal 210. There are many methods and algorithms for determining whether to authorize the candidate terminal 210. For example, in accordance with some embodiments of the invention, the candidate terminal 210 can include a profile manager module 212 that communicates with the supplier terminal 220 by sending a registration request 242 to the supplier terminal 220 to register the candidate terminal 210 with the supplier terminal 220 and receive network access profile information 252 from the supplier terminal 220. The registration request 242 can include information identifying a wireless access point that the candidate terminal 210 desires network access profile for. In accordance with some embodiments of the invention, the request 242 can include user information and some or all of the user information can be found (such as, by searching) in a database, such as contacts list or an authorized user list stored on the supplier terminal 220. The authorization module 222 can also present a message or dialog box to the user of the supplier terminal 220 requesting the user to authorize the user of candidate terminal 210 to receive the network access profile. Upon confirmation, the network access profile message 244 can be sent to the candidate terminal 210. The candidate terminal 210 can include a computer processor and associated memory and execute one or more computer programs that provide, in cooperation with the hardware components (e.g., radios and network interfaces), the functionality described herein. The candidate terminal 210 can use the network access profile information to access the wireless network (e.g., WiFi) owned or operated by the user of the supplier terminal 220. The candidate terminal 210 can use the wireless network for voice and/or data communications at that location. The candidate terminal 210 can also measure and store information about the performance of the wireless network each time it is accessed.

In accordance with some embodiments of the invention, the supplier terminal 220 can also store the network access profile information in a database or other data store in storage component 236 to enable the supplier terminal 220 to act as a profile server or proxy for other supplier terminals, for example, a common group of network operators. In this embodiment, once the other supplier terminal is registered with the supplier terminal 220, the other supplier terminal can authorize the distribution of one or more network access profiles by sending a profile message 244 identifying each user (requestor) and the network access profiles authorized for that user to the supplier terminal 220. The supplier terminal 220 can process these profile messages 244 and distribute the network access profiles accordingly. The supplier terminal 220 can also keep track of the network access profiles authorized for each requestor in a database or other data store in storage component 236. Should a user (requestor) obtain a new wireless terminal or need wireless network access from a different terminal, the user can request the network access profiles from the supplier terminal 220.

As shown in FIGS. 2 and 3, either the profile server 230, the requestor terminal 210, or the supplier terminal 220 can include a selector module 234, 224 that assists in identifying candidate users and/or candidate terminals 210, wireless networks and operators of supplier terminals 220 in order to send requests 242 to supplier terminals 220. As described herein, there are many methods and algorithms for identifying wireless networks and their owners or managers. For example, in accordance with some embodiments of the invention, based on location history and the identification of wireless access points at a given location, the selector module 234 can search for people in the contacts of the candidate terminal 210 with addresses at or near that location. Then, using the contact's email address, mobile phone number, or other identifier, the requestor module 232 can send a network access profile request 242 to that contact. In accordance with other embodiments of the invention, the selector module 234, 224 can also process candidate terminal 210 time and location information (stored either at the candidate terminal 210 or the supplier terminal 220) to identify network access points that are frequently within reach of the candidate terminal and automatically send a request access.

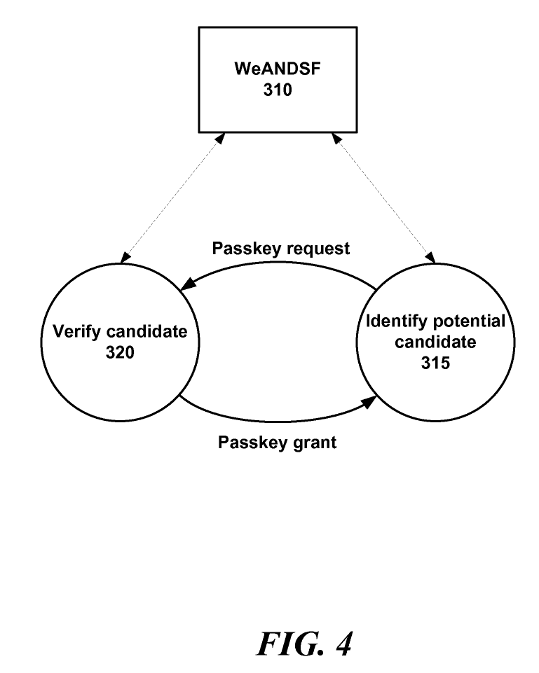

In accordance with the invention, to maintain scalability and privacy, a two-way verification & exchange procedure with optional interaction with any external server can be used. As shown in FIG. 4, candidate terminal 315 initiates the procedure by identifying an candidate using information contained in the terminal memory (contact list, call history etc.) and optionally, within other data sources, such as social networking websites (FaceBook, LinkedIn etc.) and third party databases of candidates willing to share wireless network access. Upon verification, the candidate terminal 315 can automatically or with user approval send a passkey request (wireless access profile request) to the identified candidate(s). At the supplier terminal 320, the candidate can perform a similar verification process to approve the request. Upon successful verification, the supplier terminal 320 can automatically respond by sending the passkey grant (wireless network profile information) or signaling its owner to approve the transaction—and then respond with the requested information. The verification process can be simplified when the two terminals belong to same owner (example user's PC and handset) or are part of the same company, organization or family as will be elaborated below.

### Wireless Access Profile Exchange

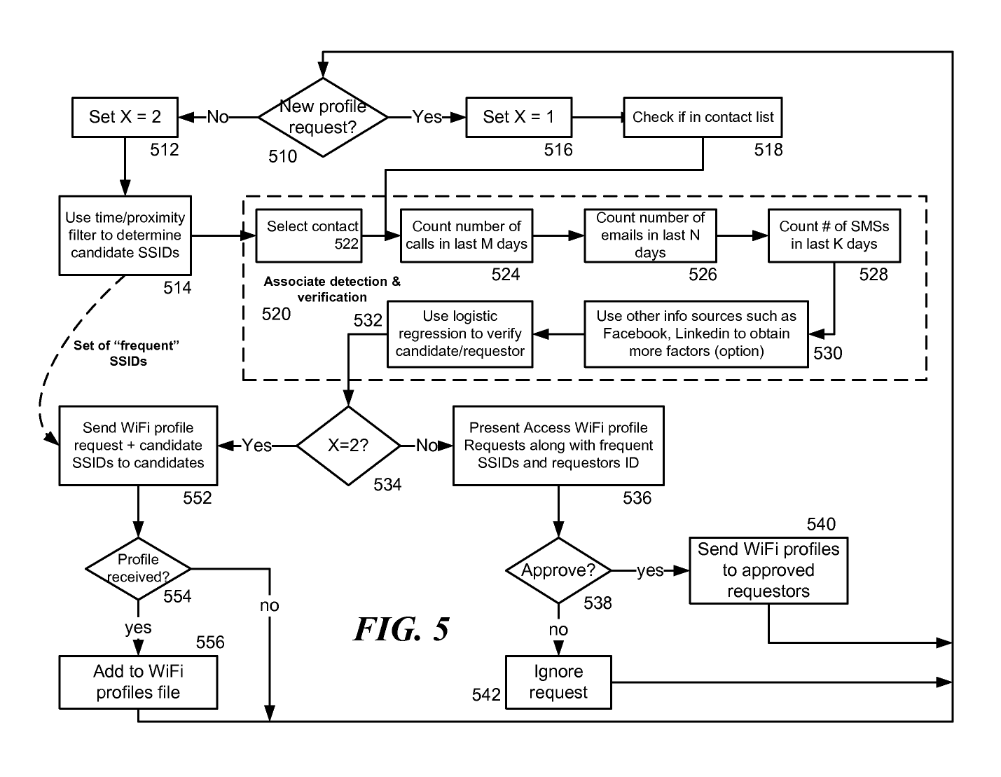

As shown in FIG. 5, each user terminal can include a procedure that can be used to detect and verify suppliers, a person or user (e.g., a network operator) that is likely to share access to the users wireless access point or router with a visiting or requesting terminal's owner.

1. Terminal checks if there is pending wireless access profile request from another terminal at 510. If no request is pending, the X flag is set to 2 at 512 and the terminal continues updating the time/proximity histogram to identify candidate SSIDs or identifiers of wireless access points that may be relevant at 514. If a pending request is found or received, the X flag is set to 1 at 516 and the terminal starts the process of verifying whether the request's source is a candidate—a person with whom there is a relationship that makes profile sharing likely at 518.

2. Associate detection and verification, 520, can include:
a. Select an entry in contact list, at 522;
b. Count number of calls that were made to and/or received from this contact in the last M days, at 524;
c. Count number of emails sent to and/or received from the contact in the last N days, at 526;
d. Count text messages (e.g., SMS, MMS) sent to and/or received from contact in last K days, at 528;
e. Optionally count number of mutual friends using a social network service, (e.g., Facebook, LinkedIn), at 530;
f. Use some or all the above values with coefficients determined through logistic regression to determine a value and compare that value to a threshold to determine whether the contact is an associate candidate, at 532;

3. If associate candidate is verified for pending profile request (X flag not equal to 2, at 534) than display the request contact in a “profile request window” for the terminal owner to review, at 536. Terminal owner can approve the request and grant access or ignore. If the terminal owner approves the request and grants access at 538, the terminal can send the wireless network access profile to the requesting candidate, at 540 and the person's status can be changed from candidate to full associate. If the terminal owner does not approve the request at 538, the request is ignored at 542.

4. If a request was not pending (X flag equal 2) and candidate was found, a profile request is sent to this candidate along with a list of SSIDs that can be associated with this candidate, at 552. The list of SSIDs can used by the supplier to verify that the request is coming from a person that had been in his house many time before, further helping in the request verification. If the requester receives a network access profile at 554, the profile is added list of wireless network (e.g., WiFi) access profiles for later use.

The time and proximity filter operation at 514 can be used to identify candidate access points. Time proximity filter can use location information (e.g., GPS location or cellular location) and time information (e.g., time of day and day of the week information) to identify candidates (a user that is likely to grant access to a wireless network access point). The filter can include:

1. Wireless (e.g. WiFi) radio can periodically scan for wireless resources (e.g., access points) within reach. And the location, a collection of SSIDs, a collection of times and their relative RSSIs can be stored in memory at the terminal.

2. Each time a specific SSID with sufficient RSSI (e.g., above a threshold) can be detected, at pre-determined time period—a counter is incremented.

3. A selection process can be used to select some or all of the SSIDs that make up a set. For example, for each access point that is detected more than M times (e.g., above a threshold), the SSID of that access point can be added to the set.

4. The set of SSIDs that were detected more than M times (M-set) can be combined into the wireless network access profile request message.

### Configuring the Network Operator Mobile Terminal

In many cases wireless access profiles are already configured and stored in a home or office personal computer (PC) of the network access point operator. Configuring mobile devices (e.g., laptop/notebook/netbook computers, mobile telephones, smart phones, iPods, PDA) to use the home or office (and other) wireless networks (WiFi) by accessing available wireless access points and routers can be performed by transferring one or more wireless access profile or configurations file between the operator PC and the operator mobile device. Transferring wireless access profiles from a operator PC to the operator mobile terminal is a special case that can be very useful in a home or small office environment. Since this configuration involves transferring wireless access profiles between terminals owned by the same user, some of the verification stages mentioned above can be eliminated.

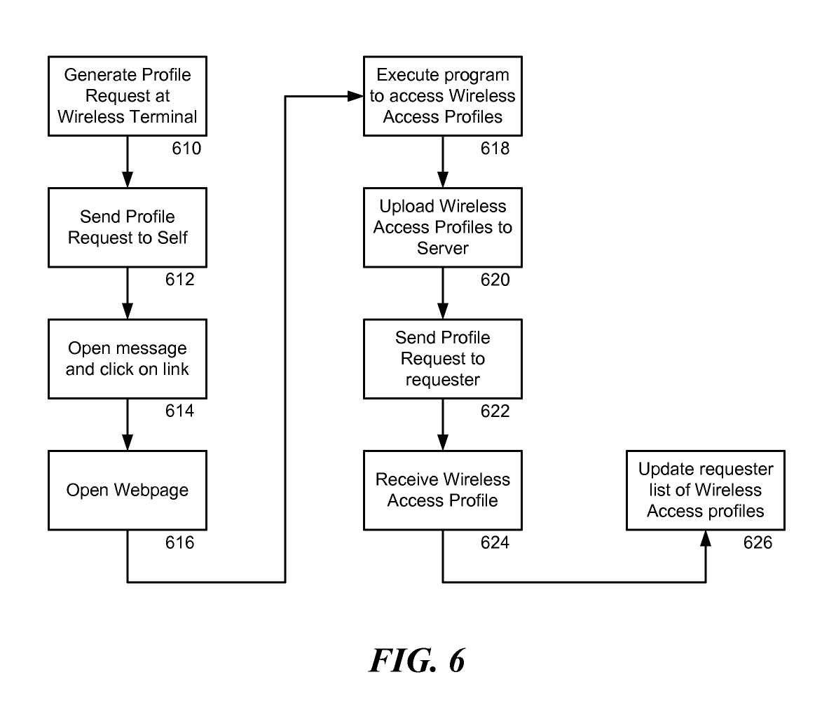

FIG. 6 shows a flow chart 600 of a method according to one embodiment of the invention for configuring a network operator terminal.

1. A wireless access profile request can be generated by the mobile terminal at 610 and sent at 612, for example, using email to oneself. As a result, the email message appears on both terminals—the PC and the mobile terminal.

2. While ignoring the email on the mobile terminal, user can open the email at the PC and click on an attached link at 614. The link can open a webpage at 616 that asks user's approval to activate program code or a script (e.g. via Active-X, Java) that is able to access the PC's operating system and using available Application Programming Interfaces (APIs) to access and retrieve the desired wireless access profiles at 618.

3. The program code or script can extract the wireless access profiles and upload them to a web server at 620. This web-server can belong to trusted entity such as the user's cellular carrier.

4. The web-server can than send the wireless access profile information to the mobile terminal at 622, (and optionally erase the information from the server after confirmation that the wireless access profile was received, to protect the user's-privacy).

5. The wireless access profile information can be received at the mobile terminal at 624 and can be added to the mobile terminal wireless access profiles, at 626, such that when terminal is in sufficient proximity to the associated wireless access points or routers, a connection is automatically establish and voice and/or data services can be offloaded onto the wireless network.

To enable easy connection to wireless infrastructure, operators can use existing connection management applications that implement methods such as Wireless Internet Service Provider roaming or WISPr. Another example is the well-known WeFi connection manager that allows, in addition to methods like WISPr, seamless connection to any public hotspots, finding WiFi in neighborhood etc. In accordance with one embodiment of the invention, the WiFi connection manager can be used to host the functionality described above.

In some cases, it can be a challenge to entice users to download and install applications on their PC and generally, some value or a clear reward can be provided to entice user to doing this. For example, an operator can offer seamless connection to his or his partners' hotspots if subscriber activates an application (e.g., WiFi connection manager) on his PC. In many cases, mobile operators do not have direct access to their subscribers' terminals, either via their mobile terminal or directly, however the operator can send an email to the subscriber explaining the benefits of the application (e.g., WiFi connection manager) and specifically explaining the mobile/PC synch method. A link attached to the email can take the subscriber through a sequence of downloading and installation of the application (e.g., WiFi connection manager).

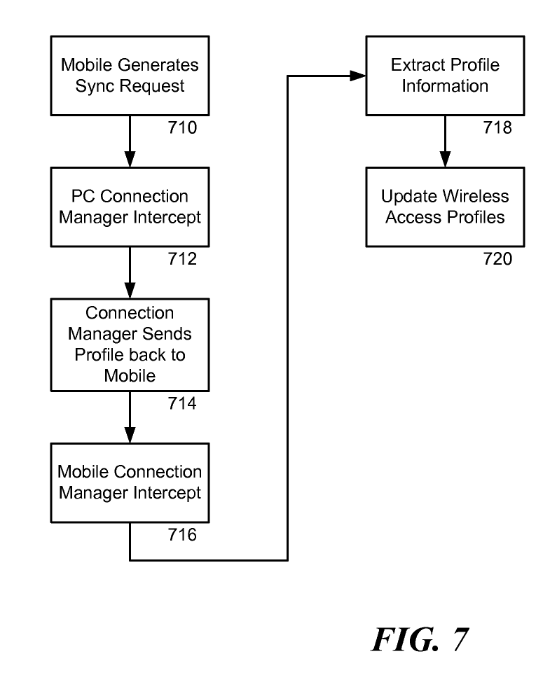

FIG. 7 provides a flow chart of how the application (e.g., WiFi connection manager) can host the above PC/mobile synchronization functionality as follows:

1. Mobile terminal generates a synch request by email at 710, which is received by the PC;

2. The connection manager intercepts the incoming email and extracts the wireless access profiles at the PC, at 712;

3. The connection manager then sends the wireless access profiles by email back to the mobile terminal at 714, for example, in a special attachment;

4. Subscriber/user then clicks on the attachment causing it to be intercepted by the mobile device's connection manager, at 716;

5. The mobile devices' connection manager extracts the profile data at 718 and adds to the wireless access profiles at the mobile terminal at 720.

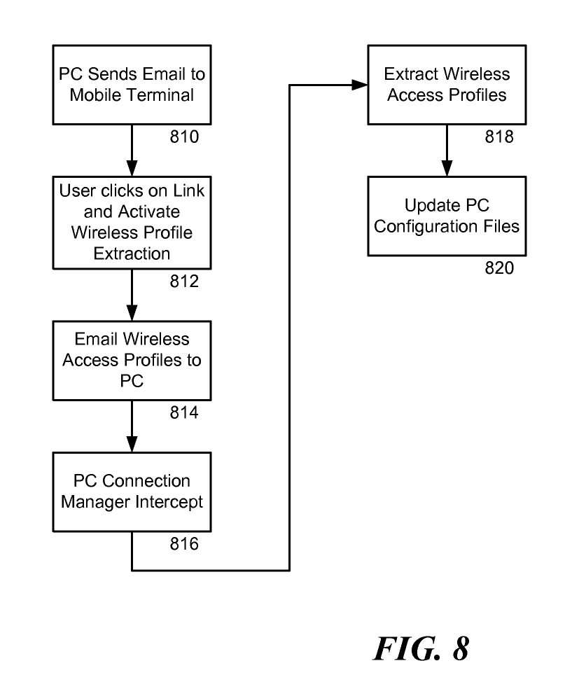

Similarly, as shown in FIG. 8, the synchronization can function to transfer the wireless access profile(s) from a mobile device to a PC:

1. PC sends an email to mobile terminal at 810;

2. User clicks on the attached link and thereby activates the wireless access profile extraction function at the mobile connection manager at 812;

3. Once the wireless access profiles are read, the connection manager can put them in an attachment and send the email back to the PC at 814;

4. The email can be intercepted at the PC by the connection manager and the attachment can be opened by the connection manager at 816;

5. The wireless access profiles can be extracted from the email attachment at 818, and written to the PC wireless configuration file at 820.

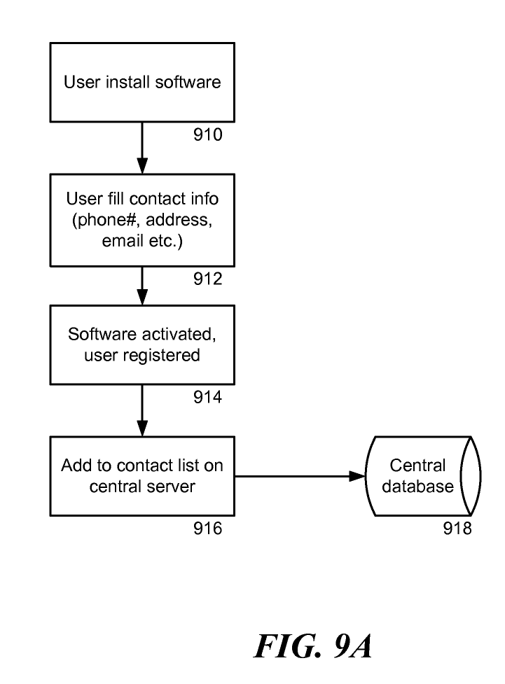

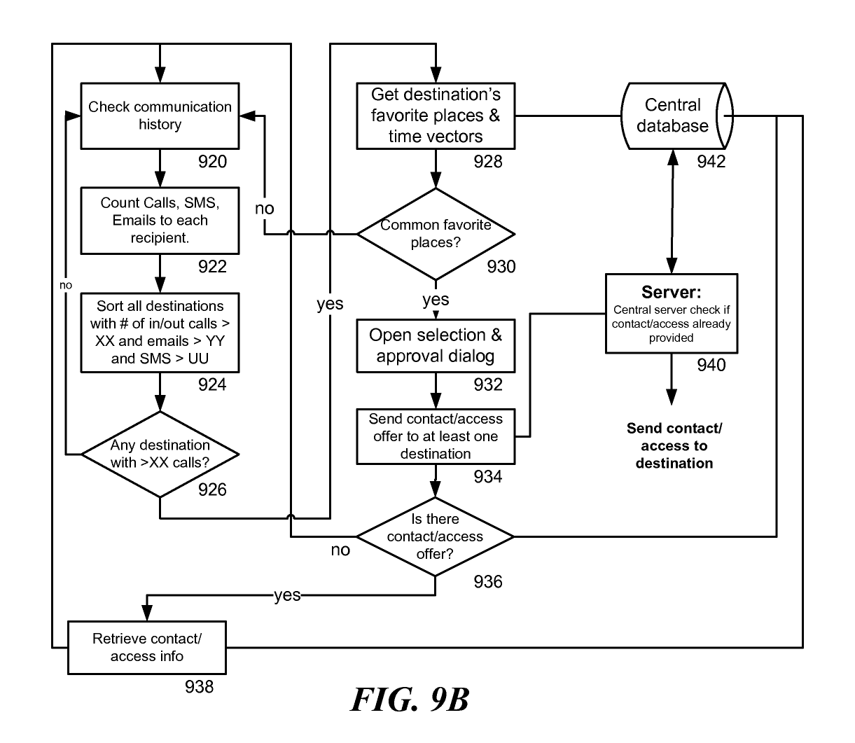

FIG. 9A shows a method according to an embodiment of the invention for registering users (suppliers and candidates). In accordance with one embodiment of the invention, the user (a supplier) of a wireless terminal installs an application (software or a program) on their wireless device at 910. As part of the installation, the user inputs and the software stores user contact information, including for example, name, one or more telephone numbers, one or more addresses, one or more email addresses, and other user information at 912. By entering the user information, the software can be activated and the user can be registered at 914. Alternatively, the software can be activated upon installation. In addition, the user contact information can be forwarded, such as over a wireless network, to a central server at 916 and stored in a central data store or database at 918.

Where the user is a supplier or network operator, the user can identify any wireless network access points that the user desires to share access and the wireless network access point information can be associated with the user. Where the network access point is within range of the user terminal, the application can detect the access point and obtain the access point identifier information. Where the network access point is not within range, the application can search the list of wireless access points maintained by the wireless connection manager of the user terminal and, for example, ask the user to select the names of the access points it would like to share. The application can obtain the network access profile information from configuration file maintained by the connection manage and provide that information to be stored in the central data store or database 918.

Where the user is a candidate user or a candidate terminal desiring network access profile information, information identifying a candidate user and/or a candidate terminal can be stored in the central data store or database 918. The identifying information can include candidate user login name and password, and candidate terminal name and/or MAC address.

FIG. 9B shows the operation of the software according to one embodiment of the present invention. In this embodiment, the software application is executed on the wireless device and processes the supplier (user) communication history to identify other users (candidates) that communicate frequently with the supplier at 920. For example, the software can process the call history, email history and/or sms history to count the number of calls or messages with each potential recipient within a predetermined time period at 922, the calls and messages can be sorted by the count of calls or messages to each destination at 924 and determine if the number of calls, email messages, and/or sms messages (either separately or combined, e.g. into a measure of relatedness or a relationship or sharing metric) are greater than a threshold at 926. A measure of relatedness can be determined as a function of the counts or quantity of calls and/or messages between the supplier and the candidate (e.g. the total number within a predefined time period). If so, a potential recipient is identified, the software can optionally receive the candidate's favorite place and time information (e.g., vectors) at 928 and compare them with the supplier's favorite place and time information (e.g., vectors) to see if there common favorite places or places where the supplier and the candidate have met within a predetermined time at 930. If at least one common favorite place can be identified, present a dialog to the supplier suggesting or asking whether to approve the candidate for access to the supplier's wireless network at 932. If the supplier approves the candidate, the software can retrieve the wireless network access profile information and forward it to the candidate. Alternatively, if the supplier approves the candidate, the software can communicate with the central server to authorize the central server 940 to retrieve the wireless network access profile information and forward it to the candidate at 934. In some embodiments of the invention, the supplier can authorize the candidate to gain access to more than one wireless network owned or managed by the supplier.

If the candidate has the software application installed on their wireless device, the software application can receive the wireless network access profile information and store it in memory so that when the candidate terminal is in range of the supplier's wireless access point, the candidate terminal can use the wireless network access profile information to access the supplier's wireless network access point. In addition, where the candidate is registered with the central server and the central server is authorized to forward the wireless network access profile information to the candidate, the central server can communicate with all of the candidate terminals (e.g., phones, tablets, computers, etc.) that are registered such that each device can gain access to the supplier's wireless network. In some embodiments of the invention, the candidate can be granted access to more than one wireless network owned or managed by the supplier.

If the supplier does not grant access to the candidate, the software continues looking at communications with other potential candidates and processes the communication information to determine if they can identify other potential candidates with relatively high levels of relatedness or relationship metrics. In addition to or as an alternative to, looking at communication history, the software application can also look at other information and data that indicates a relationship between the supplier and the candidate. This information can include, for example, “friends” or “family” attributes or tags indicated on third party (e.g., social networking) databases or websites. In accordance some embodiments of the invention, a level of relatedness can be determined, for example, where the supplier and the candidate have a number of friends or followers in common on a third party or social networking website or database. In accordance with some embodiments of the invention, some third party databases and websites record when a user is at or checks in at a location (e.g., a restaurant, night club or other place) and a level of relatedness can be determined, for example, based on the frequency of how often the supplier and the candidate are present at the same location at or for the same time, over a predefined time period.

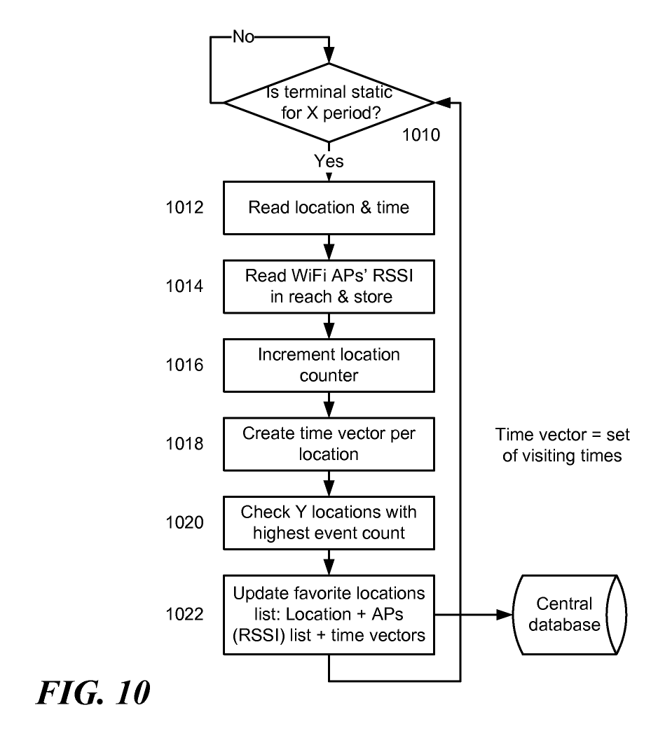

FIG. 10 shows a method determining common favorite places according to one embodiment of the present invention. Each time the wireless user candidate terminal is static for a predefined period of time (e.g., 30 minutes) at 1010 the software records in memory the position (e.g., GPS location or WiFi assisted location), the orientation, time of day and/or date or day of the week at 1012 and the identifiers of any wireless access points within reach. Orientation can provide some indication of whether the user is seated at a desk (such as at work) or standing. The wireless user device can, for example, determine that the user is static, (e.g., not moving) by taking comparing multiple orientation samples to see if the wireless user device has moved substantially (e.g., small orientation changes indicate little or no movement). Alternatively, the wireless device can scan for WiFi access points periodically and record the access points identified (SSID, MAC address and, e.g., RSSI) and then compare the access points identified in successive scans with the previously identified access points at 1014. If new access points are not being identified over a period time, the user can be considered static.

After the software determines that the wireless user device has been static for a predetermined period of time, the software can determine the location, time and date information and wireless access point information, and store that information in memory at 1012. In addition, each location can be associated with a counter that gets incremented every time the candidate terminal is determined to be static in a given location for a predetermined period of time at 1016. When the count for a specific location reaches or exceeds a predetermined threshold, that location can be indicated as a “favorite location.” In some embodiments, the counters can be reset after a predetermined time, number of hours, days, weeks or months. In some embodiments, the software can also store in memory a set of time vectors for each location, which include a time or time window and a counter for each time or time window and favorites can include an indication of an associated time or time window at 1018. The locations with the highest counts or highest count over period of time can be indicated as a “favorite location,” at 1020. The favorite locations along with time or time windows or time vectors can be sent to the central server and stored in the central database at 1022.

Most laptops or portable computers and many tablets do not include a cellular radio and cannot communicate over a cellular or mobile telephone network, these device are likely to store the user's most relevant and/or commonly used WiFi network access profile information. The process described with respect to FIGS. 9A, 9B and 10 can be used to synchronize this WiFi network access profile information with the user's mobile devices (e.g., phones, etc.)

In accordance with some embodiments of the invention, the candidate user terminal can see or detect access points and identify access points having at least a predefined signal strength and report information about the access points detected to a central server or a network operator terminal. The information reported can include an identifier for the access point, an identifier for the candidate terminal (e.g., phone number, MAC address or email address) and time, date and location information.

In accordance with some embodiments of the invention, information about the communication history and the time and location information or vectors of the candidate user can be used to determine a sharing metric. In accordance with some embodiments of the invention, the sharing metric can be determined based on information stored on a candidate terminal and used to determine a sharing metric for a wireless access point to trigger or cause an application executed on the candidate terminal to request access to a wireless network access point form the network operator (e.g., a high sharing metric indicates a high likelihood that the network operator will approve the request for access). In accordance with some embodiments of the invention, the sharing metric can be determined based on information stored on a the supplier terminal or profile server terminal. The communication history and the time and location information or vectors of one or more candidate users can be sent to the profile server and the sharing metric can be determined by an application executed on the supplier terminal or the profile server. To preserve their privacy, the identify of a given candidate user can be blocked from view at the supplier terminal until the sharing metric is determined or it determined to be over a predefined threshold (e.g., to suggest granting access).

In accordance with one embodiment of the invention, the sharing metric value can be determined by:

SMᵢ=[(kₚₕ·#phone_callsᵢ·average_call_durationᵢ+kₛₘ·#SMSsᵢ)··(aggregate_visit_duration)ᵢ+(recip_factor_function)]

### Where:

SMᵢ—sharing metric related to a user (i)

In some embodiments of the invention, the SM can be calculated for a group or community members (e.g., employees or club members) that had some minimum phone calls or SMS exchanges thereby reducing the amount of calculations. When SM becomes larger than a predefined sharing threshold the candidate can be added to the sharing list.

Kph—weight factor for phone calls

# phone_calls—number of phone calls during defined period (calls' rate)

Average_call_duration—average call duration calculated based on calls with this specific participant

# SMSs—number of SMS messages exchange during defined period (SMSs' rate)

Ksm—weight factor for SMSs

Aggregated_visit_duration—Amount of time spent at specific participant's place during defined period

Recip_factor_function value can be defined as follows:

K_{RC}, with probability >50% if sharing candidate already shared his access with participants

K_{RC}, with probability <50% if sharing candidate did not yet share access with participant

Where K_{RC}—reciprocity weight.

Example, if a candidate already shared access to a network access point, the SM value as related to that user can incremented K_{RC} with probability that is greater than 50%. For example, if K_{RC}=100 and the selected probability is 90% that every 9 out 10 determinations of SM can be increased by 100 (SM can be increased more quickly). If access was not shared yet by a candidate, and selected probability is 10%, that the SM can be incremented by 100 more slowly, one out of 10 determinations.

In accordance with some embodiments of the invention, a sharing metric can be determined for some or all of the users that a user of a wireless terminal communicates with. In this embodiment, the SM is a function of closeness and reciprocity with respect to any given user or group of users. In accordance with other embodiments of the invention, the SM can be determined as a function of the closeness without the reciprocity factor or as a function of the reciprocity without the closeness factor.

In accordance with some embodiments of the invention, a list of likely candidate terminals or candidate users can be transferred to the network operator. Each candidate on the list can be selected by calculating a sharing metric (SM) and comparing to some defined “sharing threshold.” The sharing metric size depends on the relationship level and the willingness of the candidate to reciprocate hence the reciprocity factor being part of the expression. The probabilistic approach is intended to avoid “dead-lock”. For example:

SM=CLOSENESS+RECIPROCITY.

If, RECIPROCITY is a fixed value, for example, 0 (peer did not share yet) SM will be some value that may never exceed the sharing threshold. Hence we use probabilistic approach. Giving that the RECIPROCITY element gets high value sometimes means that SM will exceed the sharing threshold sometimes. For example: if RECIPROCITY gets large value 10% of the time hence exceed the sharing threshold and consequently roughly every 10 SM determinations non-sharing peer will be added to the list and get granted. Similarly, if peer already shared, RECIPROCITY element will get large value; say 90% of the time hence will be added to the list almost following every SM determination (9 out 10).

The likelihood to be put on the candidate list can be used to determine the potential savings presented to the participant (by offloading):

$$E [ savings ] = E \{ {K}_{D} [ {\sum }_{1}^{{N}_{p}} Liklihood\_put \_on {\_list}_{i} \cdot Average\_visit {\_duration}_{i} ] \}$$

### Where:

KD—Conversion factor (service volume->money)

Likelihood_put_on_listᵢ—Likelihood to be on the list of peer (i), determined experimentally during sharing process (two values for all (i):—before peer shared and after peer shared)

Average_visit_durationᵢ—average duration of visits to candidate peer's place (i)

For example, after installing the sharing application, the software starts identifying close relationship sharing candidates. Since initially, “visiting information” is not available, the application displays a list of candidates that is only based on phone calls and SMS history. As time goes by, more information becomes available and the candidate list gets extended accordingly. As described above, the network operator can select candidates for sharing from a presented list contacts. At each selection, the application can re-calculate the expected savings to encourage participation.

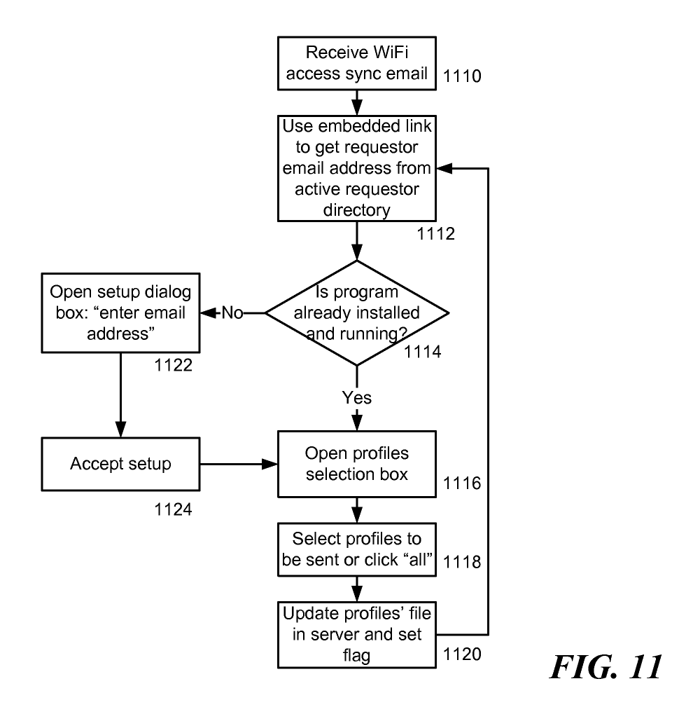

FIG. 11 shows a method for updating or syncing WiFi network access profile information from a laptop or other wireless device according to an embodiment of the invention. In this embodiment, the mobile terminal (or the central server) can send an email message to the laptop, at 1110. The email can include an embedded link to a website (or an executable attachment) at 1112 that enables the laptop to either install the software on the laptop at 1122 (if it is not installed already at 1114) or execute the software application already installed on the laptop at 1116. The software is then executed 1116 and the user can be presented with a list of available WiFi network access profile information to be shared with the user's other wireless devices (e.g., smart phones and/or tablets) at 1118. The WiFi network access profile information to be shared can either be sent directly to one or more of the user's other wireless devices or the information can be forwarded to the central server 1120. At the central server, the user's file or record can be stored or updated to indicate other destination devices (e.g., self or smart phone id). The user's other wireless devices can communicate with the central server and request that the WiFi network access profile information be sent. In addition, at any point, should any of the user's wireless devices be upgraded or replaced, the user need only install and register the software application and instruct it to retrieve the WiFi network access profile information from the central server.

In accordance with some embodiments of the invention, a synchronization process can be used to synchronize network access profiles from a user PC to the wireless user terminal. Using the synchronization process, the network access profiles (SSID & password, password is optional) can be copied from the user PC to the wireless user terminal in the event the information or device is lost or becomes corrupt.

If the synchronization program is already installed on the PC then the operation can be fully automated and no user involvement is needed.

If the synchronization program is not yet installed on PC, an email can be sent to and received at the PC with link to download the synchronization program. Once the synchronization program is downloaded and installed, it can configured to become a permanent service on both PC and the wireless user terminal. Synchronization can occur automatically, for example on a period basis or in response to an event.

In accordance with some embodiments of the invention, the network access profiles stored at the wireless user terminal can be shared using a network access profile sharing utility.

1. The sharing utility can process the contacts list and other user information to identify candidates (other users) for sharing and prompts the user with a notification window.

2. When the user responding to the sharing notification, the sharing utility can present a list of people to share network access profiles with and let the user select a set of candidates for sharing.

3. Once the set of candidates is selected, a set of WiFi SSIDs can be presented to enable the user to select a set of network access profiles to be shared with the set of candidates.

4. Upon confirmation, the selected set of profiles can be shared—the network access profiles can be sent to the set of candidates.

Since most candidates are selected from people that are closely related to the user and also tend to be near WiFi access points that are frequently visited by both users and candidates, it is highly likely that following the sharing process, shared candidate may be automatically connected to WiFi. Consequently we are effective allowing on person to connect another person to WiFi remotely. This creates opportunities as described below.

In accordance with some embodiments of the invention, the sharing process can be used for application activation. In this embodiment, the sharing process can be used to initiate the installation and execution of WiFi related applications such as video-chat, VoIP, broadcasting etc. The process can include:

1. After a candidate gets connected to the wireless network, a connection notification can be sent back to sharing user;

2. Upon receiving the connection notification, wireless user can send a request to the candidate to launch a selected application (for example, a video chat application);

3. If the application has not yet been installed at the candidate wireless terminal, a link to download and install the application can be sent to him;

4. The selected application can be launched on the candidate user device;

5. And both wireless user and candidate can start using the selected application to communicate.

For example, the application can be a video streaming application, such as “USTREAM” broadcasting to enable the user to broadcast video to a set of candidates:

1. The user can execute the sharing process as described above;

2. After receiving the connection notifications from a subset of the selected candidates, the user can activate the USTREAM application and send request to the subset;

3. The selected candidates either install USTREAM or just execute it and select the proper viewing channel (provided by the sharing user);

4. The user can start broadcasting and the candidates can watch.

The above description describes how to use the sharing platform to enable users to encourage others to use various applications that require WiFi. The user can share WiFi in order to encourage the use of a favored application.

When a business owner (say coffee-shop, restaurant, store etc.) wants to stimulate traffic to his store he can use the following procedure:

1. The business owner can share his business WiFi profile with one or more customers of whom he knows, e.g., he knows their phone number or email address;

2. The business owner can offer these customers a reward (depend on the business type) that is function of the number of users that these customers share the business WiFi with;

3. When the WiFi access is shared, there can be an option to open a content webpage, for example, each time a customer receives access to the WiFi of the business.

4. This is could be a chain process where customers that “got shared WiFi” can further share and enjoy some reward as well based on how many other customers they managed to share this WiFi with.

5. The sharing process can follow the same procedures described above, including the possibility of enablement of WiFi related applications. Some of these applications can present information related to the original business owner.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A method for providing a candidate terminal with a network access profile for accessing a network through a wireless network access point, the method comprising:
the candidate terminal receiving an access point identifier from the wireless network access point;
the candidate terminal associating the network access point with a wireless network operator identifier;
the candidate terminal sending a request for a network access profile, for accessing the network through the wireless network access point, to the wireless network operator;
the candidate terminal receiving the network access profile for accessing the network through the wireless network access point

2. The method according to claim 1 wherein the candidate terminal associates the network access point with the operator identifier as a function of location information for the wireless network access point and location information of the operator

3. The method according to claim 1 wherein the candidate terminal associates the network access point with the operator's identifier as a function of candidate user input information.

4. The method according to claim 1 wherein the candidate terminal associates the network access point with the network operator identifier as a function of social network information.

5. A method for providing a candidate terminal with a network access profile for accessing a network through a wireless network access point, the method comprising:
storing at a network operator terminal, the network access profile for accessing the network through the wireless network access point;
receiving from a candidate terminal, a request for a network access profile for accessing the network through the wireless network access point, the request including a candidate identifier and a wireless network access point;
determining a quantity of communications between the network operator terminal and the candidate terminal from historic information stored on the network operator terminal;
determining whether to send the requested network access profile as a function of said quantity of communications; and
sending the requested network access profile to the candidate terminal.

6. The method according to claim 5 wherein the historic information includes information about a quantity of telephone calls with the candidate terminal.

7. The method according to claim 5 wherein the historic information includes information about a quantity of email messages sent to or received from the candidate terminal.

8. The method according to claim 5 wherein the historic information includes information about a quantity of text messages sent to or received from the candidate terminal.

9. The method according to claim 5 further including requesting confirmation from a user of the owner terminal to send the requested network access profile to the candidate terminal.

10. A method for providing a candidate terminal with a network access profile, for accessing a network through a wireless network access point, the method comprising:
storing at a network operator terminal, the network access profile for accessing the network through the wireless network access point;
identifying at least one candidate terminal as function of a quantity of communications between the network operator terminal and the candidate terminal; and
sending the network access profile to the candidate terminal.

11. The method according to claim 10 further comprising determining a measure of relatedness as function of at least one of a quantity of telephone calls, a quantity of email messages and a quantity of text messages transferred between the network operator terminal and the candidate terminal within a predefined time period.

12. The method according to claim 10 wherein the network access profile is sent to the candidate terminal if the quantity of communications between the network operator terminal and the candidate terminal is greater than a predefined threshold.

13. The method according to claim 10 wherein the candidate terminal is associated with a candidate user and the network operator terminal is associated with a network operator; and identifying at least one candidate terminal includes identifying at least one candidate terminal as function of information indicating a relationship between the network operator and the candidate user.

14. The method according to claim 13, wherein the information indicating a relation includes at least one of the following:
information about the candidate user in a contact list on the network operator terminal;
information about the candidate user found in a third party database;
information about the candidate user found in a social networking database; and
location information about the candidate user and the network operator.

15. The method according to claim 10 wherein the candidate terminal sends to central server information about network access points seen by the candidate terminal having at least a predefined level of signal strength over a predefined time period and the sent network access profile is for one of the network access points previously seen by the candidate terminal.

16. The method according to claim 10 wherein the network operator terminal is associated with a network operator and the method further includes presenting a message on the network operator terminal to request that the network operator confirm the sending of the network access profile to the candidate user.

17. The method according to claim 10 wherein the network access profile is sent to a central database for subsequent delivery to the candidate terminal.

18. The method according to claim 10 wherein the network access profile is sent to the candidate terminal in an email message.

19. The method according to claim 10 wherein the candidate terminal is sent an email message containing a link whereby selecting the link at the candidate terminal causes the network access profile to be downloaded to the candidate terminal.
